(19) United States
(12) Patent Application Publication
(10) Pub. No.: US 2016/0123040 A1
(43) Pub. Date: May 5, 2016

(54) PADLOCK LOCK BOX

(71) Applicant: bbotx, Inc., Calgary (CA)

(72) Inventors: Paul Hanson, Calgary (CA); Scott Wilson, Calgary (CA)

(21) Appl. No.: 14/928,095

(22) Filed: Oct. 30, 2015

Related U.S. Application Data
(60) Provisional application No. 62/072,948, filed on Oct. 30, 2014.

(51) Int. Cl. E05B 67/02; E05B 67/38

(52) U.S. Cl. CPC E05B 67/02; E05B 67/38

(57) ABSTRACT

A lock box includes a front shell, a rear shell, and a padlock retention clasp. The rear shell is interlockable with the front shell to move the lock box from an open lock box position to a closed lock box position. The padlock retention clasp is cooperatively formed from the front shell and the rear shell. The padlock retention clasp is configured to admit a padlock body between the front shell and the rear shell in the open lock box position and to retain the padlock body between the front shell and the rear shell in the closed lock box position. The padlock retention clasp is further configured to prevent opening of the lock box while a shackle of the padlock is locked into the padlock body and the padlock body is retained between the front shell and the rear shell in the closed lock box position.

### CROSS REFERENCE TO RELATED APPLICATIONS

This application claims priority to U.S. Provisional Patent Application No. 62/072,948, filed Oct. 30, 2014, which is hereby incorporated herein by reference in its entirety.

### SUMMARY

A lock box includes a front shell, a rear shell, and a padlock retention clasp. The rear shell is interlockable with the front shell to move the lock box from an open lock box position to a closed lock box position. The padlock retention clasp is cooperatively formed from the front shell and the rear shell. The padlock retention clasp is configured to admit a padlock body between the front shell and the rear shell in the open lock box position and to retain the padlock body between the front shell and the rear shell in the closed lock box position. The padlock retention clasp is further configured to prevent opening of the lock box while a shackle of the padlock is locked into the padlock body and the padlock body is retained between the front shell and the rear shell in the closed lock box position.

### BRIEF DESCRIPTION OF THE DRAWINGS

FIG. 1 shows a front-side perspective view of an example padlock lock box.

FIG. 2 shows a rear-side perspective view of the lock box of FIG. 1.

FIG. 3 shows the lock box of FIG. 1 in an open position and a shackle of the padlock rotated out.

FIG. 4 shows the lock box of FIG. 1 in an open position and a shackle of the padlock aligned to be locked.

FIG. 5 shows the shackle of the padlock of FIG. 1.

FIG. 6 shows a front padlock retention clasp portion of the lock box shown in FIG. 1.

FIG. 7 shows a rear padlock retention clasp portion of the lock box lock box shown in FIG. 1.

### DETAILED DESCRIPTION

The present description relates to a lock box configured to be locked by a removable padlock. More particularly, the lock box may be configured to interface with a shackle of a padlock to integrate the padlock into the lock box. When the lock box is placed in a closed lock box position, the lock box may form an internal payload cavity in which various items may be securely stored. Further, when a shackle of the padlock is placed in a locked position to lock the padlock, the internal payload cavity of the lock box may be inaccessible, thus protecting contents within the internal payload cavity of the lock box. Further, when the shackle of the padlock is placed in an unlocked position to unlock the padlock, the lock box may be moved to an open lock box position to allow access to the internal payload cavity of the lock box and the contents stored therein. As such, the lock box and the removable padlock cooperate to function as a lock box.

The lock box may add secure storage functionality to a standalone padlock without any modification of the padlock. Moreover, when the padlock is installed within the lock box, the lock box will not interfere with the locking functionality of the padlock. In other words, the padlock may provide the same locking functionality whether or not the lock box is installed on the padlock. The combination of the lock box and the padlock may provide a secure storage solution for any item that fits within the closed lock box. Moreover, the combination of the lock box and the padlock may provide a portable storage solution that may be secured to any suitable fixture in any suitable location. In some implementations, the padlock and the lock box may be integrated into a unified lock box in which the padlock is not separable from the lock box.

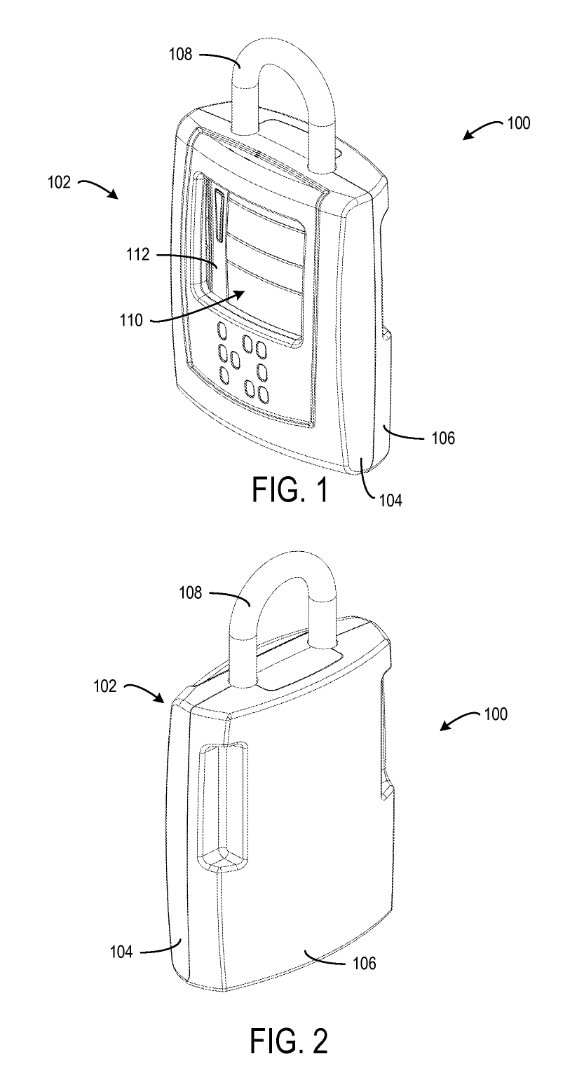

FIGS. 1 and 2 show an example lock box 100 and padlock 102. The lock box 100 includes a front shell 104 and a rear shell 106 that interface with each other while surrounding the padlock 102 to place the lock box 100 in a closed lock box position. The padlock 102 includes a shackle 108 that is shown in a locked position. In particular, the lock box 100 interfaces with the shackle 108 to maintain the lock box in the closed lock box position while the shackle is in the locked position. Accordingly, an internal payload cavity of the lock box may be inaccessible while the shackle 108 is in the locked position.

The front shell 104 optionally forms a window 110 that opens to a portion of a padlock body 112. In some implementations, the padlock body 112 may at least partially protrude through the window 110. In other implementations, the padlock body 112 may be flush with or recessed behind the window 110. In yet other implementations, the front shell may not include a window.

In the illustrated example, the padlock 102 is an electronic padlock that communicates with an electronic key device via a secure wireless connection (e.g., Bluetooth) to unlock the electronic lock device. For example, a wireless radio connection between the electronic padlock and an electronic key device may be formed through the window 110. In other implementations, the padlock 102 may include a keyhole, combination lock, and/or biometric scanner that may be accessible via the window 110. Note that although a portion of the lock device may be exposed via the window 110, the front shell 104 of the lock box may cooperate with the body 112 of the padlock to prevent access to an internal payload cavity of the lock box 100 through the window 110.

The lock box 100 may be configured such that the padlock 102 is initially set on the rear shell 106 so that the lock box 100 opens to the front. By initially setting the padlock 102 on the rear shell 106 of the lock box 100, the front shell 104 may be allowed to pivot forward to the open lock box position. Such an implementation may be particularly applicable to a scenario where the padlock/lock box is locked against a surface. For example, the padlock may be locked on a door handle such that the lock box hangs against the outer surface of a door. In this implementation, the lock box may be opened by rotating the front shell without having to remove the padlock from the door handle. In other implementations, the orientation may be reversed.

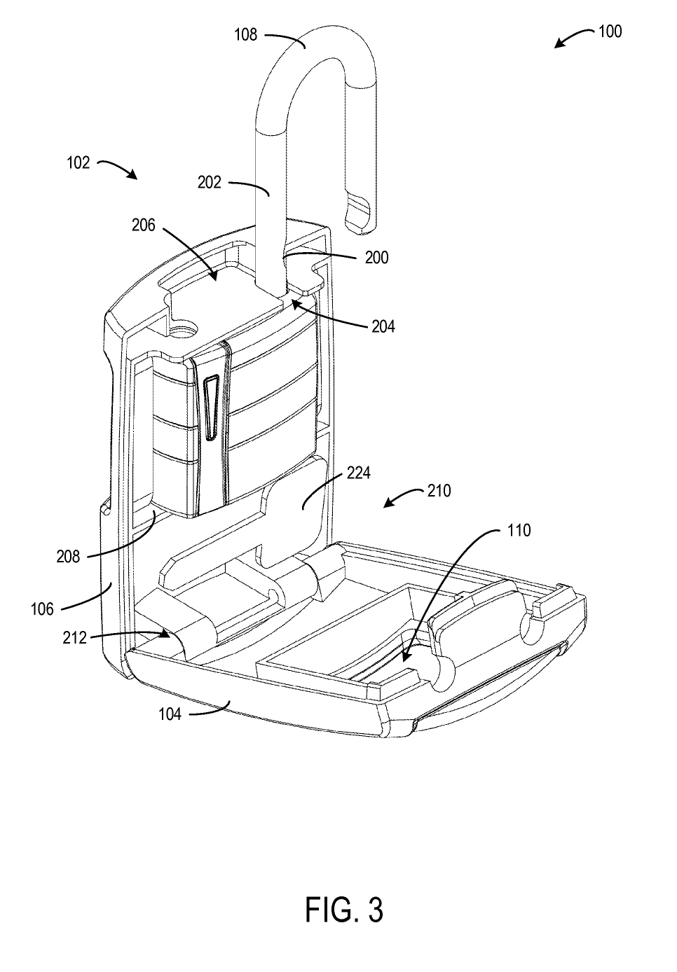

FIG. 3 shows the lock box 100 of FIG. 1 in an open lock box position and the shackle 108 of the padlock 102 in an unaligned position that allows the padlock 102 to be installed in the lock box 100. The unaligned position of the shackle 108 is a position in which the shackle 108 cannot be locked into the padlock body 112. In order to install the padlock 102 in the lock box 100, the shackle 108 may be rotated such that a narrow notch segment 200 formed in a right shackle arm 202 of the shackle 108 aligns with a narrow path portion of a rear-right shackle retention slot 204 defined by a rear padlock retention clasp portion 206 of the rear shell 106. In the illustrated example, the narrow path portion of the rear-right shackle retention slot 204 is positioned such that the path portion only aligns with the narrow notch segment 200 when the right shackle arm 202 is in the unaligned position which is rotated one hundred and eighty degrees from an aligned position. The aligned position is a position at which the shackle 108 can be locked into the padlock body 112. When the shackle is in the unaligned position the path portion of the rear-right shackle retention slot 204 transversely admits only the narrow notch segment 200 of the right shackle arm 202. In other words, the narrow notch segment 200 must be longitudinally aligned with the rear-right shackle retention slot 204 in order for the right shackle arm 202 to be transversely admitted into the rear-right shackle retention slot 204.

Note that the narrow notch segment 200 of the right shackle arm 202 may longitudinally align with the rear-right shackle retention slot 204 in any suitable manner. In some implementations, the narrow notch segment 200 of the right shackle arm 202 may longitudinally align with the rear-right shackle retention slot 204 when the shackle 108 is fully undepressed or at a maximum longitudinal extension. In other implementations, the shackle 108 may need to be slightly depressed in order to longitudinally align the narrow notch segment 200 of the right shackle arm 202 with the rear-right shackle retention slot 204.

A shelf 208 is formed within the rear shell 106 and positioned below the window 110. The shelf 208 may be configured to hold the padlock 102 in a fixed position such that the body 112 of the padlock 102 is aligned with the window 110. In particular, the shelf 208 may be spaced a distance from the rear padlock retention clasp portion 206 to create a tension fit when the padlock 102 is installed in the lock box 100 to hold the padlock in place. Furthermore, the shelf 208 may prevent the padlock 102 from dropping into an internal payload cavity 210 when the padlock 102 is installed in the lock box 100.

A hinge 212 pivotably connects the front shell 104 and the rear shell 106. The hinge 212 allows the front shell 104 to pivot relative to the rear shell 106 for movement of the lock box 100 between a closed lock box position and an open lock box position. When the lock box 100 is in the open lock box position, the internal payload cavity 210 can be accessed, for example to store or retrieve an item 224. Furthermore, the hinge 212 may allow the front shell 104 to remain coupled with the rear shell 106 when the lock box 100 is in the open position. In the closed lock box position, the front shell 104 and the rear shell 106 collectively form the internal payload cavity 210 that is inaccessible when the lock box is in the closed lock box position.

In some implementations, the hinge may be omitted and the front shell and the rear shell may be separable from each other. In such implementations, the front shell and rear shell may include cooperating mating sections (e.g., male and female sections) formed around the perimeter of each portion that allow the front shell and the rear shell to seal and close off the internal payload cavity 210. In some implementations, the front and rear shells may collectively form an interlocking structure that prevents the front and rear shells from being separated when the lock box is placed in the closed lock box position and the padlock is locked. The interlocking structure may take any suitable form. In one example, the interlocking structure may include a tongue and groove configuration. The interlocking structure may be formed at any suitable position on the front and rear shells. In one example, the interlocking structure may be positioned at a base of the front and rear shells.

In the illustrated example, the item 224 that is stored in the internal payload cavity 210 is a key, such as a house key. In some implementations, the internal payload cavity 210 may be specifically shaped to hold a key. The internal payload cavity may be sized and shaped to hold any suitable item without departing from the scope of the present disclosure.

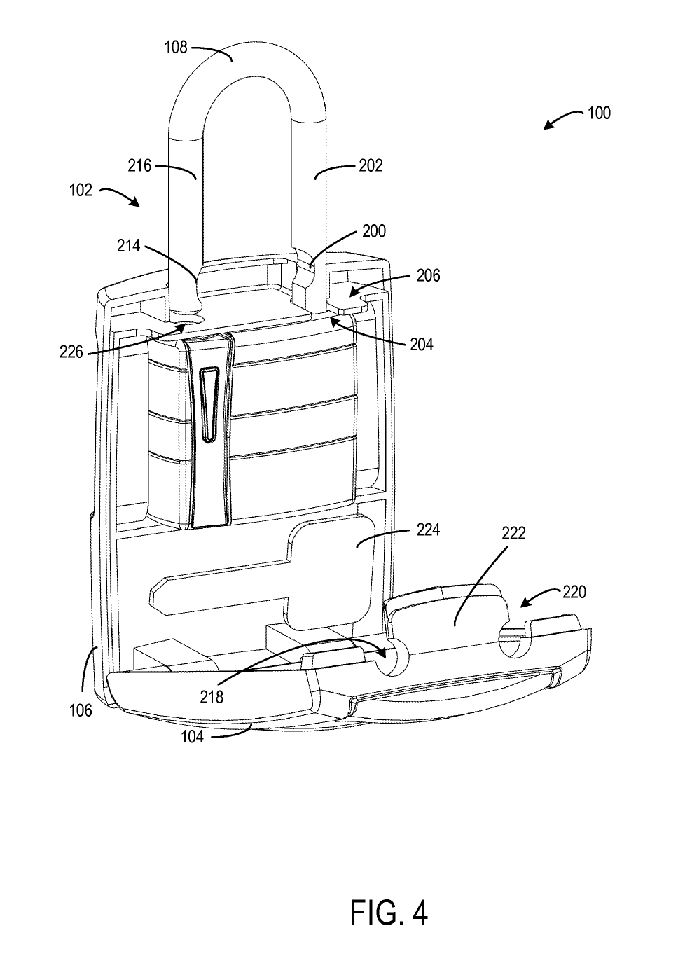

FIG. 4 shows the lock box 100 of FIG. 1 in the open lock box position and the shackle 108 of the padlock 102 in the aligned position. In order to close the lock box 100 around the shackle 108, the narrow notch segment 200 of the right shackle arm 202 must be positioned to longitudinally align with a front-right shackle retention slot 220 defined by a front padlock retention clasp portion 222. Further, a narrow notch segment 214 of a left shackle arm 216 of the shackle 108 must be longitudinally aligned with a front-left shackle retention slot 218 defined by the front padlock retention clasp portion 222. In other words, the shackle 108 may be aligned to be locked, but not actually locked (e.g., slightly pressed down) so that the narrow notch segments 200 and 214 longitudinally align with the shackle retention slots 220 and 218. According to such an alignment, the front-right shackle retention slot 220 transversely closes around the right shackle arm 202 and the front-left shackle retention slot 218 transversely closes around the left shackle arm 216 so that the front shell 104 can completely close against the rear shell 106.

Furthermore, the rear padlock retention clasp portion 206 defines a rear-left shackle retention aperture 226. The rear-left shackle retention aperture 226 may be sized to longitudinally admit the left shackle arm 216. When the lock box 100 pivots into the closed lock box position, the front-left shackle retention slot 218 and the rear-left shackle retention aperture 226 may be aligned to longitudinally admit the left shackle arm 216 of the padlock 102 so that the left shackle arm 216 can be locked into the body 112 to place the padlock 102 in the locked position.

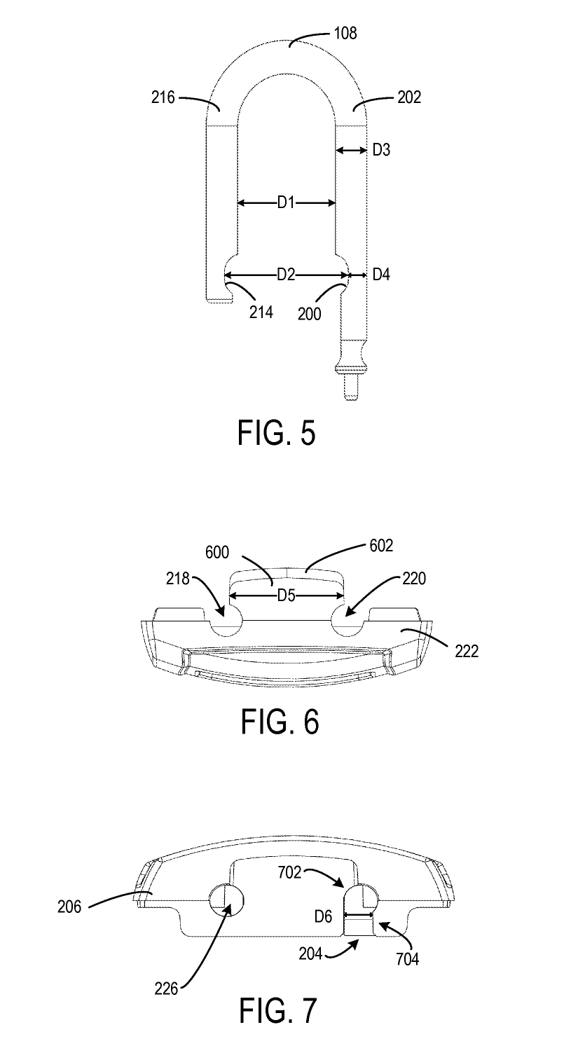

FIG. 5 shows the shackle 108 of the padlock 102. The shackle 108 includes the right shackle arm 202 including the narrow notch segment 200 and the left shackle arm 216 including the narrow notch segment 214. The right shackle arm 202 and the left shackle arm 216 may be spaced apart a distance D1 as measured from an inner edge of a thickest portion of each shackle arm. Further, a distance D2 measured between the narrow notch segment 200 and the narrow notch segment 214 may be greater than the distance D1. Each of the right and left shackle arms may have a same diameter that is a distance D3 as measured at the thickest portion of each shackle arm. Further, a distance D4 of each narrow notch segment 200 and 214 may be less than the distance D3.

FIG. 6 shows the front padlock retention clasp portion 222 of the lock box 100. The front padlock retention clasp portion 222 includes the front-left shackle retention slot 218 and the front-right shackle retention slot 220. The front-right shackle retention slot 220 may be sized to transversely close around the right shackle arm 202 when the right shackle arm 202 is admitted in the rear-right shackle retention slot 204 thereby aligning the front-right shackle retention slot 220 with the rear-right shackle retention slot 204 when the lock box 100 pivots into the closed lock box position. The front-left shackle retention slot 218 and the rear-left shackle retention aperture 226 may be aligned to longitudinally admit the left shackle arm 216 of the padlock 102 locking into the padlock body 112 while the lock box 100 is in the closed lock box position.

The front padlock retention clasp portion 206 includes an intermediate portion 600 having a width that is a distance D5. The distance D5 may be greater than the distance D1 between the thicker portions of the right and left shackle arms 202 and 216 of the shackle 108. Further, the distance D5 may be less than the distance D2 between the narrow notch segments 200 and 214. As such, the shackle 108 must be positioned such that the narrow notch segments 200 and 214 are longitudinally aligned with the intermediate portion 600 in order for the intermediate portion 600 to clear the right and left shackle arms 202 and 216. In other words, the intermediate portion 600 of the front padlock retention clasp portion 206 transversely closes around the right shackle arm 202 and the left shackle arm 216 only when the shackle 108 is in the aligned shackle position and the narrow notch segments 200 and 214 are longitudinally aligned with the intermediate portion 600 (e.g., by pressing the shackle 108 slightly down). Correspondingly, the intermediate portion 600 of the front padlock retention clasp portion 222 prevents the front-right shackle retention slot 220 from transversely closing around the right shackle arm 202 while the right shackle arm 202 is in the unaligned shackle position or the narrow notch segment 200 is longitudinally offset from the intermediate portion 600. Likewise, the intermediate portion 600 of the front padlock retention clasp portion 222 prevents the front-left shackle retention slot 218 from transversely closing around the left shackle arm 216 while the left shackle arm 216 is in the aligned shackle position and the narrow notch segment 214 is longitudinally offset from the intermediate portion 600.

Note that the narrow notch segments of the shackle arms may longitudinally align with the intermediate portion and the front-right and front-left shackle retention slots in any suitable manner. In some implementations, the narrow notch segments of the shackle may longitudinally align with the intermediate portion when the shackle is fully undepressed or at a maximum longitudinal extension. In other implementations, the shackle may need to be slightly depressed in order to longitudinally align the narrow notch segments with the intermediate portion of the front padlock retention clasp.

Once, the intermediate portion 600 has transversely closed around the right and left shackle arms 202 and 216 such that the front shell 104 and the rear shell 106 meet, the shackle 108 may be depressed to lock the padlock 102. When the shackle 108 is depressed, the shackle arms 202 and 216 having the distance D3 may be longitudinally aligned with the intermediate portion 600. In this state, because the intermediate portion 600 has a width (the distance D5) that is greater than the distance D1 between the shackle arms 202 and 216, the lock box 100 may be prevented from pivoting into the open lock box position while the padlock 102 is locked. In other words, the intermediate portion 600 of the front padlock retention clasp portion 222 prevents the lock box 100 from pivoting into the open lock box position while the narrow notch segments 200 and 214 are longitudinally offset from the intermediate portion 600.

Furthermore, the front padlock retention clasp portion 222 may include a recessed lip 602 that spans the perimeter of the front padlock retention clasp portion 222. When the lock box 100 is placed in a closed lock box position where the front padlock retention clasp portion 222 and the rear padlock retention clasp portion 206 interface, the recessed lip 602 may internally overlap the rear padlock retention clasp portion 206 to close any gap that may exist between the two padlock retention clasp portions. Such an overlap may inhibit a foreign object from being wedged between the two padlock retention clasp portions in an attempt to pry open the lock box 100. In some implementations, the front padlock retention clasp portion may overlap the rear padlock retention clasp portion when the lock box pivots into the closed lock box position. More generally, any portion of either shell may overlap the other shell to cover a gap between the shells in any suitable manner without departing from the scope of the present disclosure.

FIG. 7 shows the rear padlock retention clasp portion 206 of the lock box 100. The rear padlock retention clasp portion 206 forms the rear-right shackle retention slot 204 and the rear-left shackle retention aperture 226. The rear-left shackle retention aperture 226 may be sized to longitudinally admit the left shackle arm 216 of the shackle 108 while the lock box 100 is in the closed lock box position to allow the padlock 102 to be placed in a locked state.

The rear-right shackle retention slot 204 may be sized to transversely admit the right shackle arm 202 of the padlock 102 while the lock box 100 is in the open lock box position. In particular, the right shackle arm 202 of the shackle 108 may be placed in a particular orientation (e.g., as shown in FIG. 3) in order to transversely align with the rear-right shackle retention slot 204. Further, the right shackle arm 202 of the shackle 108 may be placed in a different orientation (e.g., as shown in FIG. 4) to retain the shackle in the rear-right shackle retention slot 204.

The rear-right shackle retention slot 204 includes a circular portion 702 and a path portion 704. The circular portion 702 is sized to accept the thicker portion of the right shackle arm 202 having the distance D3. The path portion 704 extends from the circle portion 702 to an edge of the rear padlock retention clasp portion 206. The path portion 704 is biased to an inner side of the circular portion 702. The path portion 704 is sized to transversely admit the narrow notch segment 200 of the right shackle arm 202 having the distance D4. In particular, the path portion 704 of the rear-right shackle retention slot 204 has a width that is a distance D6. The distance D6 is less than the distance D3, but greater than the distance D4. As such, the right shackle arm 202 may only travel through the path portion 704 of the rear-right shackle retention slot 204 if the shackle 108 is rotated to the unaligned position in order to align the narrow notch segment 200 with the path portion 704. In other words, the rear-right shackle retention slot 204 is sized to transversely admit only the narrow notch segment 200 of the right shackle arm 202 while the right shackle arm 202 is in the unaligned shackle position.

It will be understood that the use of directional terms (e.g., right, left, front, rear, transverse, longitudinal) is relative to the lock box illustrated in FIGS. 1-7. Moreover, such directional terms are not limiting and are not directionally absolute. Any features described using such directional terms may be broadly applicable to other directions in other embodiments (e.g., complete or partial mirror images). As such, any reference to a direction (e.g., left, right, front, back) in the description or the claims should be interpreted only in a relative sense.

It will be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various features disclosed herein, as well as any and all equivalents thereof.

1. A lock box, comprising:
a front shell including a front padlock retention clasp portion defining a front-right shackle retention slot and a front-left shackle retention slot;
a rear shell including a rear padlock retention clasp portion defining a rear-right shackle retention slot and a rear-left shackle retention aperture;
a hinge pivotably connecting the front shell and the rear shell for movement of the lock box between an open lock box position and a closed lock box position;
the rear-right shackle retention slot sized to transversely admit a right shackle arm of a padlock while the lock box is in the open lock box position;
the front-right shackle retention slot sized to transversely close around the right shackle arm when the right shackle arm is admitted in the rear-right shackle retention slot thereby aligning the front-right shackle retention slot with the rear-right shackle retention slot when the lock box pivots into the closed lock box position;
the front-left shackle retention slot and the rear-left shackle retention aperture aligned to longitudinally admit a left shackle arm of the padlock locking into a padlock body of the padlock while the lock box is in the closed lock box position; and
an intermediate portion of the front padlock retention clasp portion having a retention width greater than a distance between the right shackle arm and the left shackle arm when the lock box is in the closed position and the left shackle arm and the right shackle arm are locked into the padlock body, thereby preventing the lock box from pivoting into the open lock box position while the padlock is locked.

2. The lock box of claim 1, wherein the right shackle arm includes a narrow notch segment and is rotatable between an unaligned shackle position and an aligned shackle position, wherein the rear-right shackle retention slot is sized to transversely admit only the narrow notch segment of the right shackle arm while the right shackle arm is in the unaligned shackle position.

3. The lock box of claim 2, wherein the intermediate portion of the front padlock retention clasp portion transversely closes around the right shackle arm only when the right shackle arm is in the aligned shackle position and the narrow notch segment is longitudinally aligned with the intermediate portion.

4. The lock box of claim 2, wherein the intermediate portion of the front padlock retention clasp portion prevents the front-right shackle retention slot from transversely closing around the right shackle arm while the right shackle arm is in the unaligned shackle position or the narrow notch segment is longitudinally offset from the intermediate portion.

5. The lock box of claim 2, wherein the intermediate portion of the front padlock retention clasp portion prevents the lock box from pivoting into the open lock box position while the narrow notch segment is longitudinally offset from the intermediate portion.

6. The lock box of claim 1, wherein the front shell defines a window to a portion of the padlock body when the lock box pivots into the closed lock box position.

7. The lock box of claim 1, wherein the front padlock retention clasp portion overlaps the rear padlock retention clasp portion when the lock box pivots into the closed lock box position.

8. The lock box of claim 1, wherein the rear shell includes a shelf spaced below the rear padlock retention clasp portion to hold the padlock in a fixed position when the padlock is installed in the lock box.

9. The lock box of claim 1, wherein the front shell and the rear shell collectively form an internal payload cavity that is accessible when the lock box is in the open lock box position and inaccessible when the lock box is in the closed lock box position.

10. A lock box, comprising:
a padlock;
a front shell;
a rear shell;
a hinge pivotably connecting the front shell and the rear shell for movement of the lock box between an open lock box position and a closed lock box position; and
a padlock retention clasp cooperatively formed from the front shell and the rear shell, the padlock retention clasp configured to admit a padlock body of the padlock between the front shell and the rear shell in the open lock box position and to retain the padlock body between the front shell and the rear shell in the closed lock box position, the padlock retention clasp further configured to prevent opening of the lock box while a shackle of the padlock is locked into the padlock body and the padlock body is retained between the front shell and the rear shell in the closed lock box position.

11. The padlock device of claim 10, wherein the front shell includes a front padlock retention clasp portion defining a front-right shackle retention slot and a front-left shackle retention slot, wherein the rear shell includes a rear padlock retention clasp portion defining a rear-right shackle retention slot and a rear-left shackle retention aperture; the rear-right shackle retention slot sized to transversely admit a right shackle arm of the padlock while the lock box is in the open lock box position, the front-right shackle retention slot sized to transversely close around the right shackle arm when the right shackle arm is admitted in the rear-right shackle retention slot thereby aligning the front-right shackle retention slot with the rear-right shackle retention slot when the lock box pivots into the closed lock box position, and the front-left shackle retention slot and the rear-left shackle retention aperture aligned to longitudinally admit a left shackle arm of the padlock locking into a padlock body of the padlock while the lock box is in the closed lock box position.

12. The padlock device of claim 11, wherein the padlock retention clasp includes an intermediate portion having a retention width greater than a distance between the right shackle arm and the left shackle arm when the lock box is in the closed position and the left shackle arm and the right shackle arm are locked into the padlock body, thereby preventing the lock box from pivoting into the open lock box position while the padlock is locked.

13. The padlock device of claim 12, wherein the right shackle arm includes a narrow notch segment and is rotatable between an unaligned shackle position and an aligned shackle position, wherein the rear-right shackle retention slot is sized to transversely admit only the narrow notch segment of the right shackle arm while the right shackle arm is in the unaligned shackle position.

14. The padlock device of claim 13, wherein the intermediate portion of the front padlock retention clasp portion transversely closes around the right shackle arm only when the right shackle arm is in the aligned shackle position and the narrow notch segment is longitudinally aligned with the intermediate portion.

15. The padlock device of claim 13, wherein the intermediate portion of the front padlock retention clasp portion prevents the front-right shackle retention slot from transversely closing around the right shackle arm while the right shackle arm is in the unaligned shackle position or the narrow notch segment is longitudinally offset from the intermediate portion.

16. The padlock device of claim 13, wherein the intermediate portion of the front padlock retention clasp portion prevents the lock box from pivoting into the open lock box position while the narrow notch segment is longitudinally offset from the intermediate portion.

17. The padlock device of claim 10, wherein the front shell defines a window to a portion of the padlock body when the lock box pivots into the closed lock box position.

18. The padlock device of claim 17, wherein the padlock is an electronic padlock, and wherein a wireless radio connection between the electronic padlock and an electronic key device is formed through the window.

19. The padlock device of claim 10, wherein the front shell and the rear shell collectively form an internal payload cavity that is accessible when the lock box is in the open lock box position and inaccessible when the lock box is in the closed lock box position.

20. A lock box, comprising:
a front shell;
a rear shell interlockable with the front shell to move the lock box from an open lock box position to a closed lock box position; and
a padlock retention clasp cooperatively formed from the front shell and the rear shell, the padlock retention clasp configured to admit a padlock body between the front shell and the rear shell in the open lock box position and to retain the padlock body between the front shell and the rear shell in the closed lock box position, the padlock retention clasp further configured to prevent opening of the lock box while a shackle of the padlock is locked into the padlock body and the padlock body is retained between the front shell and the rear shell in the closed lock box position.
